(19) United States
(12) Patent Application Publication
(10) Pub. No.: US 2011/0292149 A1
(43) Pub. Date: Dec. 1, 2011

(54) CHARGING ROLLER, CHARGING UNIT USING THE SAME, AND IMAGE FORMING APPARATUS

(75) Inventor: Kazuhiro Hara, Shizuoka-ken (JP)

(73) Assignees: TOSHIBA TEC KABUSHIKI KAISHA, Tokyo (JP); KABUSHIKI KAISHA TOSHIBA, Minato-ku (JP)

(21) Appl. No.: 13/118,849

(22) Filed: May 31, 2011

Related U.S. Application Data
(60) Provisional application No. 61/350,279, filed on Jun. 1, 2010.

(51) Int. Cl. B41J 2/01; F16C 13/00

(52) U.S. Cl. 347/104; 492/30

(57) ABSTRACT

According to one embodiment, an image forming apparatus includes a to-be-charged member, a charging roller, a feeding mechanism, a recording head portion, and a discharge mechanism. The to-be-charged member includes a dielectric body that rotates in a predetermined direction. The charging roller is disposed to face the to-be-charged member and includes a conductive roller body and insulating convex portions which has electric resistance greater than that of the roller body, is disposed in an area of the roller body in an axis direction of the roller body with intervals therebetween, and protrudes in a radial direction of the roller body. The feeding mechanism feeds a sheet between the to-be-charged member and the charging roller. The recording head portion forms an image on the sheet. The discharge mechanism discharges the sheet on which recording was performed by the recording head portion.

### CROSS-REFERENCE TO RELATED APPLICATIONS

This application is based upon and claims the benefit of priority from: U.S. Provisional Application No. 61/350,279 filed on Jun. 1, 2010, the entire contents of each of which are incorporated herein reference.

### FIELD

Embodiments described herein relate generally to a charging roller, a charging unit using the same, and an image forming apparatus.

### BACKGROUND

Conventionally, an image forming apparatus such as an ink jet recording apparatus provided with a charging unit is known. The ink jet recording apparatus provided with a charging unit includes a carriage drum which is a rotating member to be charged, the charging unit providing electric charge to the carriage drum, a recording head portion and the like. A sheet as a recording medium is fixed on the circumferential surface of the carriage drum by electrostatic force provided to the carriage drum, and rotates together with the drum. During the rotation, an image is formed on the sheet by the recording head portion.

The charging unit includes a charging roller formed of a conductive material. As a charging roller, two types including a contact type and a non-contact type of charging rollers are known. The circumferential surface of the contact type of charging roller contacts a sheet fed between the carriage drum and the charging roller. Accordingly, the contact type of charging roller can press the sheet on the circumferential surface of the carriage drum in a state of surface contact.

On the other hand, the non-contact type of charging roller does not contact the member to be charged or the sheet; therefore, this type of roller has advantages in that the roller is hardly contaminated or damaged.

However, the non-contact type of charging roller is unable to press the sheet fed between the carriage drum and the roller on the carriage drum. Consequently, in the charging unit using the non-contact type of charging roller, when the sheet is separated from the circumferential surface of the carriage drum before the carriage drum is sufficiently charged, there is a possibility that attracting of the sheet to the carriage drum and carriage of the sheet may not be performed normally.

### BRIEF DESCRIPTION OF THE DRAWINGS

FIG. 1 is a lateral view schematically illustrating the inside of an ink jet recording apparatus as an example of an image forming apparatus including a charging unit according to a first embodiment;

FIG. 2 is a lateral view illustrating an enlarged portion of the ink jet recording apparatus shown in FIG. 1;

FIG. 3 is a cross-sectional view of the charging roller taken along a line F3-F3 in FIG. 2;

FIG. 4 is a perspective view of the charging roller shown in FIG. 3;

FIG. 5 is a perspective view of the charging roller according to a second embodiment;

FIG. 6 is a perspective view of the charging roller according to a third embodiment; and

FIG. 7 is a lateral view schematically illustrating the image forming apparatus including the charging unit according to a fourth embodiment.

### DETAILED DESCRIPTION

In general, according to one embodiment, an image forming apparatus includes a to-be-charged member, a charging roller, a feeding mechanism, a recording head portion, and a discharge mechanism. The to-be-charged member includes a dielectric body that can hold a charge and rotates in a predetermined direction. The charging roller is disposed to face the to-be-charged member and includes a conductive roller body and a plurality of insulating convex portions which has electric resistance greater than that of the roller body, is disposed in an area of the roller body in an axis direction of the roller body with intervals therebetween, and protrudes in a radial direction of the roller body. The feeding mechanism feeds a sheet between the to-be-charged member and the charging roller. The recording head portion forms an image on the sheet held on the to-be-charged member. The discharge mechanism discharges the sheet on which the recording was performed by the recording head portion.

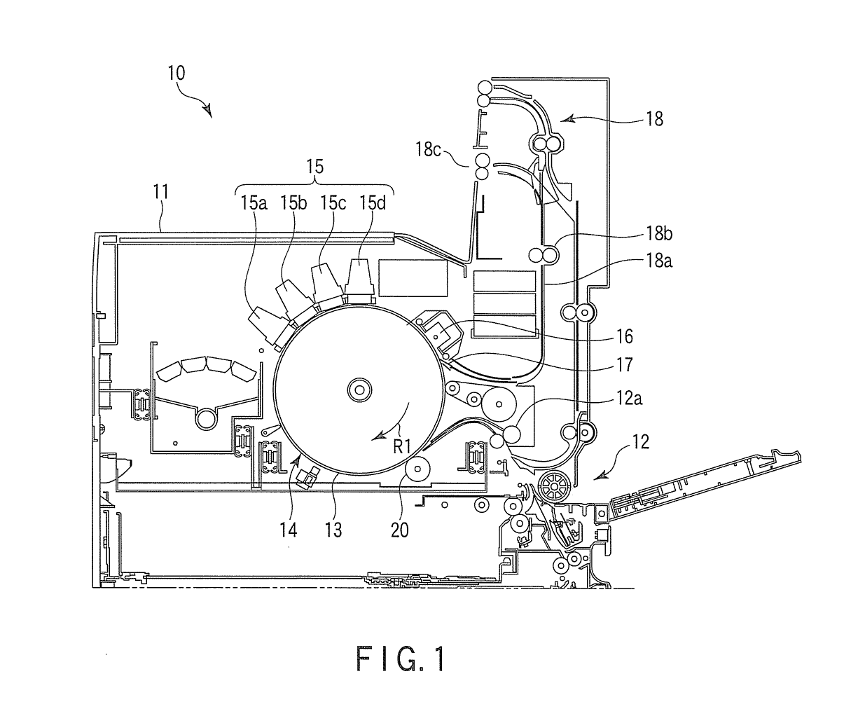

Hereinafter, a first embodiment of an image forming apparatus including the charging unit will be described with reference to FIGS. 1 to 4.

FIG. 1 illustrates an ink jet recording apparatus 10 which is one embodiment of the image forming apparatus. The ink jet recording apparatus 10 is covered by a housing 11. The ink jet recording apparatus 10 includes a sheet feeding mechanism 12, a charging unit 14, a recording head portion 15, a sheet discharge mechanism 18, and the like. The charging unit 14 includes a to-be-charged member 13 which functions as a carriage drum for carrying a sheet S, a discharger 16, a sheet peeling mechanism 17, a charging roller 20 providing electric charge to the to-be-charged member 13, and the like.

The to-be-charged member 13 can rotate at a certain circumferential speed in a direction indicated by an arrow R1 in FIG. 1 by a rotation mechanism (not shown). The recording head portion 15 includes a plurality ink jet recording heads 15a, 15b, 15c, and 15d for each color, which can perform color printing. The sheet feeding mechanism 12 contains a plurality of sheets as recording media. The sheet discharge mechanism 18 includes a carriage guide 18a, a carriage roller 18b, and a discharge port 18c.

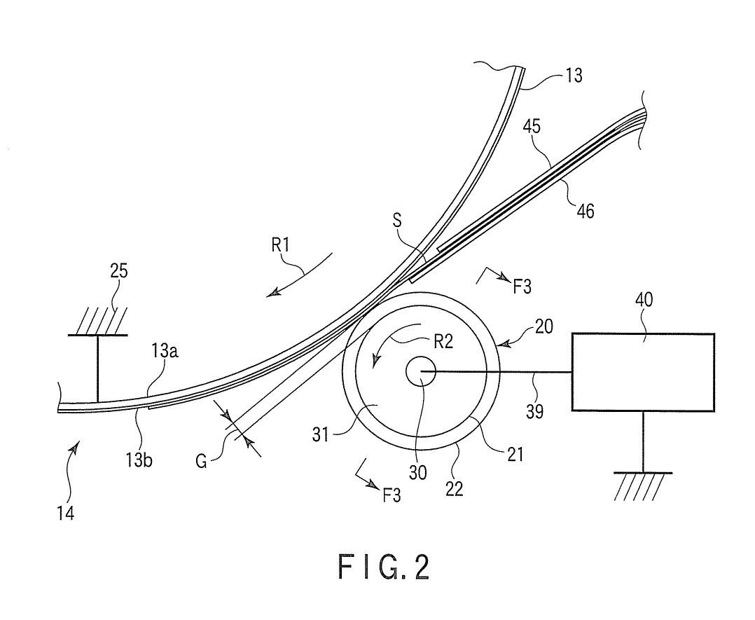

FIG. 2 illustrates a portion of the charging unit 14. The to-be-charged member 13 includes, for example, a drum body 13a formed of a metal such as aluminum alloy and a dielectric body 13b formed on the circumferential surface of the drum body 13a. The drum body 13a is grounded to a ground 25. The dielectric body 13b is formed of, for example, a resin film such as a polyester film, and is fixed to the circumferential surface of the drum body 13a. As another example of the dielectric body 13b, a dielectric material such as a polyfluoroethylene-based resin may be coated on the circumferential surface of the drum body 13a. The charging roller 20 is disposed to face the to-be-charged member 13. A mandrel 30 of the charging roller 20 is connected to a power-supply device 40 through an electric path 39 (shown in FIG. 2). The power-supply device 40 applies direct voltage (DC voltage) to a roller body 21 through the mandrel 30. Through the DC voltage (for example, several thousands of volts), the charge electrostatically attracting the sheet S is generated in the dielectric body 13b. The sheet S is fed between the to-be-charged member 13 and the charging roller 20 by guiding members 45 and 46.

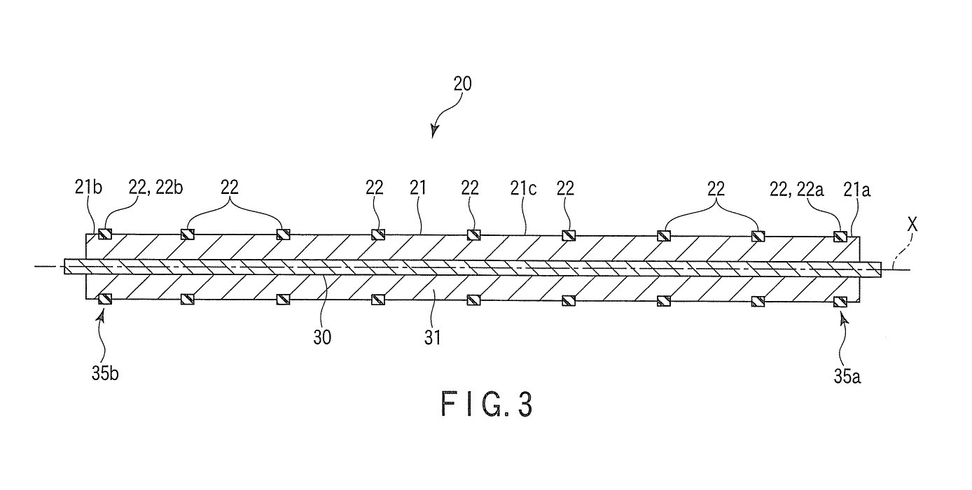

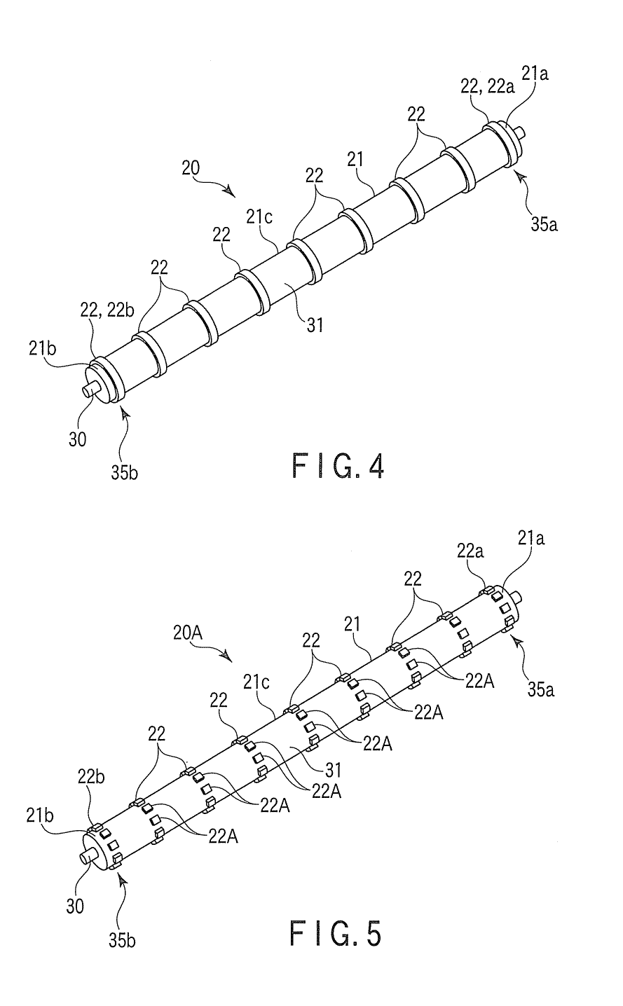

FIG. 3 illustrates the cross section of the charging roller 20 taken along a line F3-F3. FIG. 4 is a perspective view of the charging roller 20. The charging roller 20 includes the roller body 21 and a plurality (three or more) of insulating convex portions 22. The roller body 21 includes an axis X (shown in FIG. 3) as a rotation center. The axis X extends in a longitudinal direction of the roller body 21. The roller body 21 includes an area having a predetermined length in the direction of the axis X as a rotation center and is a cylindrical body in which each portion in the direction of the axis X has the same diameter.

The roller body 21 includes an end portion 21a at one side in the longitudinal direction, an end portion 21b at the other side, and an area 21c between these end portions 21a and 21b. The charging roller 20 can rotate around the axis X. An arrow R2 shown in FIG. 2 is the rotational direction of the charging roller 20. The roller body 21 includes the mandrel 30 formed of a metal, and a cylindrical conductive member 31 provided outside the mandrel 30. The conductive member 31 is formed of a conductive material selected from conductive rubbers or metals. An example of the conductive rubber includes EPDM (ethylene-propylene-dienomethylene rubber) in which a conductive filler is mixed.

The convex portions 22 are formed of a material having the value of electric resistance greater than that of the roller body 21. The convex portions 22 are substantially formed of an elastic material with an electric insulating property (the value of volume resistivity is 1×10¹⁰ Ω·cm or more). Each of the convex portions 22 forms rings consecutive in the circumferential direction of the roller body 21. These convex portions 22 are disposed in the circumferential surface of the roller body 21 at a predetermined pitch and with intervals therebetween in the direction of the axis X of the roller body 21. Moreover, the convex portions 22 are formed of a material (for example, a synthetic rubber) which has a friction coefficient greater than that of the dielectric body 13b of the to-be-charged member 13 and more easily performs elastic deformation than the dielectric body 13b. That is, the convex portions 22 are formed of an elastomer which has a deformation amount larger than that of the dielectric body 13b when a compression load is applied thereto.

The friction coefficient of the convex portions 22 with respect to the sheet S is, for example, 0.3, but may be equal to or higher than this value. The friction coefficient of the dielectric body 13b with respect to the sheet S is, for example, 0.1 or less, for example, but the value may be equal to or higher than this. The elastic modulus of the convex portions 22 is smaller than that of the dielectric body 13b, for example, about 100 MPa, but the value may vary. As a material of the convex portions 22, a material that has better abrasion resistance than the roller body 21 is suitable. An example of the material of the convex portions 22 includes EPDM having an insulating property, but other elastic materials may also be used.

Among the convex portions 22, convex portions 22a and 22b positioned at the both end portions 21a and 21b of the roller body 21 can contact the circumferential surface of the to-be-charged member 13 constantly. Accordingly, the rotation of the to-be-charged member 13 can be transmitted to the charging roller 20 through the convex portions 22a and 22b. As a result, between the to-be-charged member 13 and the charging roller 20, transmission portions 35a and 35b using friction are configured. By the transmission portions 35a and 35b, the charging roller 20 can rotate following the rotation of the to-be-charged member 13 at the same circumferential speed.

The rotation of the to-be-charged member 13 may be transmitted to the charging roller 20 through a power transmission member such as a gear or a belt instead of the transmission portions 35a and 35b. Alternatively, by using a dedicated rotation mechanism for rotating the charging roller 20, the charging roller 20 may be rotated in synchronization with the to-be-charged member 13. In any case, the charging unit 14 includes a mechanism rotating the charging roller 20 at the circumferential speed corresponding to the circumferential speed of the to-be-charged member 13.

When the leading ends of the convex portions 22 of the charging roller 20 contact the sheet S, the sheet S is pressed on the to-be-charged member 13 by the convex portions 22, in a state of a plurality of lines. Simultaneously, by the DC voltage applied to the charging roller 20, the charge is generated in the dielectric body 13b of the to-be-charged member 13. The sheet S is attracted to the dielectric body 13b by the electrostatic force. The to-be-charged member 13 and the charging roller 20 rotate in the direction of the arrows R1 and R2 respectively at a certain speed; therefore, the sheet S moves in the direction indicated by the arrow R1 at a certain speed along with the to-be-charged member 13.

Since the convex portions 22 contact the sheet S, it is possible to restrict the distance between the roller body 21 and the sheet S according to the height of the convex portions 22, that is, the protrusion amount of the convex portions 22 from the circumferential surface of the roller body 21. The size of a gap G (shown in FIG. 2) between the roller body 21 and the sheet S is several tens to several hundreds of μm, for example.

In this manner, since it is possible to reliably restrict the gap G between the roller body 21 and the sheet S by using the convex portions 22, the charge provided to the sheet S is stabilized. Furthermore, it is possible to press the sheet S on the to-be-charged member 13 by using the convex portions 22. Accordingly, it is possible to prevent the sheet S from being separated from the to-be-charged member 13 before the sheet S is sufficiently charged, and to make the sheet S be reliably fixed to the to-be-charged member 13. Moreover, it is possible to assist the carriage of the sheet S by using the convex portions 22. Consequently, since the sheet S is carried to the recording head portion 15 while being reliably held by the to-be-charged member 13, carriage defection such as so-called paper jam is prevented.

The discharger 16 includes a function of applying AC voltage to the sheet S attracted to the to-be-charged member 13 by using a corona discharger, for example. By providing the AC voltage to the to-be-charged member 13 and the sheet S, the discharger 16 cancels the electrostatic force by which the to-be-charged member 13 attracts the sheet S.

Hereinafter, the outline of the printing process using the ink jet recording apparatus 10 will be described.

The sheet S carried to a registration roller (also referred to as an aligning roller) 12a of the sheet feeding mechanism 12 is temporarily stopped by the registration roller 12a. After aligning the position of the leading end of the sheet S, the registration roller 12a rotates again, whereby the sheet S is fed between the to-be-charged member 13 and the charging roller 20. The sheet S is interposed between the dielectric body 13b of the to-be-charged member 13 and the convex portions 22 of the charging roller 20. The DC voltage is applied to the charging roller 20 by the power-supply device 40. Accordingly, a portion of the sheet S facing the charging roller 20 is charged with an electric charge of a first polarity, and the dielectric body 13b of the to-be-charged member 13 is charged with an electric charge of a second polarity. Due to these charges, the sheet S is electrostatically fixed to the to-be-charged member 13.

The sheet S fixed to the to-be-charged member 13 moves in the direction R1 in which the to-be-charged member 13 rotates, along with the to-be-charged member 13. In a case of color printing, when the sheet S reaches a first recording head 15a, a first ink is ejected to the sheet S from the first recording head 15a. The sheet S rotates while being fixed to the to-be-charged member 13 and reaches a second recording head 15b. Then a second ink is ejected to the sheet S from the second recording head 15b. Further, when the to-be-charged member 13 rotates, a third ink is ejected to the sheet S from a third recording head 15c. Moreover, when the to-be-charged member 13 rotates, a fourth ink is ejected to the sheet S from a fourth recording head 15d. While the to-be-charged member 13 rotates plural times in this manner, a color image is formed on the sheet S. That is, the ink jet recording apparatus 10 performs color printing using a line head type multi-pass method.

The AC voltage is applied to the sheet S printed by the recording head portion 15 by means of the discharger 16. As a result, since the electric charge on the surface of the sheet S decreases, the attracting force of the sheet S with respect to the to-be-charged member 13 is weakened. Furthermore, by the sheet peeling mechanism 17, the sheet S is peeled off the to-be-charged member 13. The peeled sheet S passes through the carriage guide 18a and carriage roller 18b and is discharged to the outside of the housing 11 from the discharge port 18c.

FIG. 5 illustrates a charging roller 20A according to the second embodiment. The convex portions 22 of the charging roller 20A are formed of a plurality of convex elements 22A provided in the circumferential direction of the roller body 21 with intervals therebetween. Other configurations and actions of the charging roller 20A are common to the charging roller 20 of the first embodiment; therefore, sites common to both the charging rollers are marked with common reference numerals and description thereof will be omitted. If the charging roller 20A in FIG. 5 is used, the leading ends of convex portions 22A of the charging roller 20A contact the sheet S, whereby the sheet S is pressed on the to-be-charged member 13 by the convex portions 22A, in a state of a plurality of points.

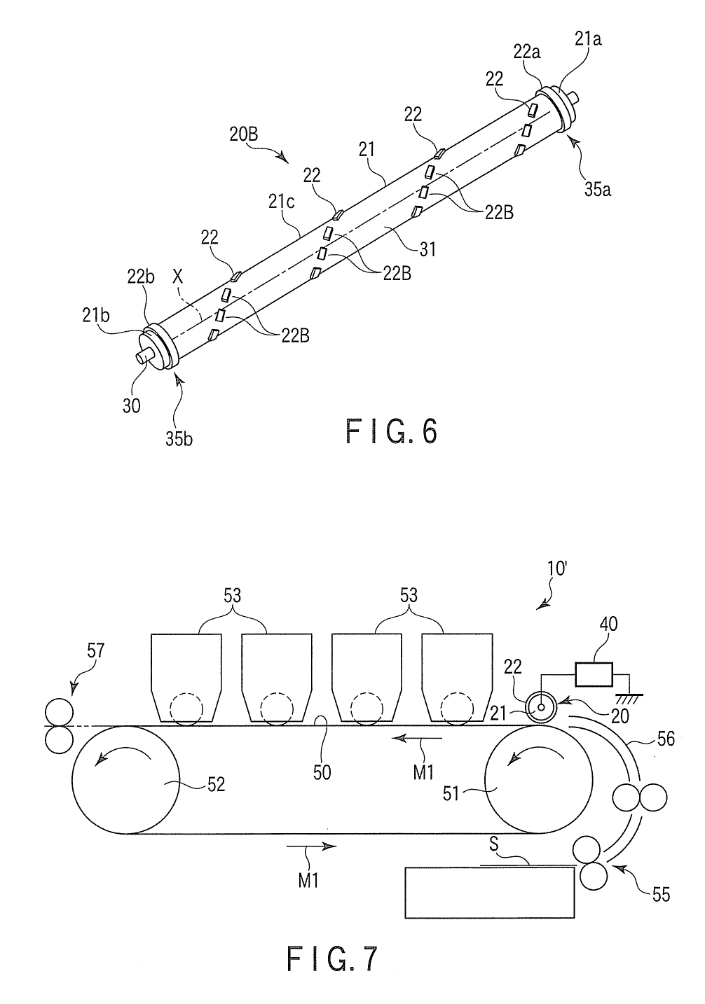

FIG. 6 illustrates a charging roller 20B according to the third embodiment. The convex portions 22 of the charging roller 20B are formed of a plurality of convex elements 22B disposed in a direction spiral with respect to the axis X of the roller body 21. Other configurations and actions of the charging roller 20B are common to the charging roller 20 of the first embodiment; therefore, sites common to both the charging rollers are marked with common reference numerals and description thereof will be omitted. If the charging roller 20B in FIG. 6 is used, the leading ends of convex portions 22B of the charging roller 20B contact the sheet S, whereby the sheet S is pressed on the to-be-charged member 13 by the convex portions 22B, in a state of a plurality of points.

The charging roller disclosed in the present specification can also be used in a charging unit of an image forming apparatus other than the ink jet recording apparatus. For example, the charging roller can be used in a charging unit for an image carrier built into a copy machine or MFP (Multi-Functional Peripheral).

FIG. 7 illustrates an image forming apparatus 10′ according to the fourth embodiment. The image forming apparatus 10′ includes a to-be-charged member 50 functioning as a transfer belt. The belt-like to-be-charged member 50 is stretched between first and second rotation bodies 51 and 52, and cyclically moves in a direction indicated by an arrow M1 endlessly by a driving mechanism (not shown). Along a movement direction M1 of the to-be-charged member 50, a charging roller 20 and a transfer unit 53 for transferring an image are disposed. The charging roller 20 of the image forming apparatus 10′ is configured in the same manner as the charging roller 20 described in the first embodiment.

The sheet S shown in FIG. 7 passes through a carriage path 56 from a sheet feeding mechanism 55 and is fed between the charging roller 20 and the to-be-charged member 50. The charging roller 20 provides charge for electrostatic adsorption to the to-be-charged member 50 and the sheet S. While the sheet S moves in the direction indicated by the arrow M1 along with the to-be-charged member 50, images for each color are formed in the transfer unit 53. The sheet S on which the images have been formed are discharged from a sheet discharge mechanism 57. In the image forming apparatus including the belt-like to-be-charged member 50, the charge can also be provided to the to-be-charged member 50 by the conductive roller body 21, and it is possible to press the sheet S on the to-be-charged member 50 by using the convex portions 22 having the electric insulating property.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A charging roller comprising:
a roller body which is formed of a conductive material and includes an area with a predetermined length in the direction of an axis as a rotation center; and
a plurality of convex portions which is formed of a material with electric resistance higher than that of the roller body, disposed in the area of the roller body in the axis direction of the roller body with intervals therebetween, and protrudes in a radial direction of the roller body.

2. The charging roller according to claim 1,
wherein each of the convex portions forms a ring consecutive in a circumferential direction of the roller body.

3. The charging roller according to claim 1,
wherein each of the convex portions is formed of a plurality of convex elements provided in the circumferential direction of the roller body with intervals therebetween.

4. The charging roller according to claim 1,
wherein the roller body includes a mandrel along the axis and a cylindrical conductive member provided outside the mandrel.

5. A charging unit comprising:
a to-be-charged member including a dielectric body which can hold charge, and rotating or undergoing endless movement in a predetermined direction; and
a charging roller disposed to face the to-be-charged member and including a conductive roller body which includes an area with a predetermined length in the direction of an axis as a rotation center and a plurality of convex portions with electric resistance greater than that of the roller body, is disposed in the area of the roller body in the axis direction of the roller body with intervals therebetween, and protrudes in a radial direction of the roller body.

6. The charging unit according to claim 5,
wherein the to-be-charged member is a rotating drum including the dielectric body on the circumferential surface thereof.

7. The charging unit according to claim 5,
wherein the to-be-charged member is an endless rotating belt including the dielectric body on the circumferential surface thereof.

8. The charging unit according to claim 5,
wherein each of the convex portions forms a ring consecutive in circumferential direction of the roller body.

9. The charging unit according to claim 5,
wherein each of the convex portions is formed of a plurality of convex elements provided in the circumferential direction of the roller body with intervals therebetween.

10. The charging unit according to claim 5,
wherein the roller body includes a mandrel along the axis of the roller body and a cylindrical conductive member provided outside the mandrel.

11. The charging unit according to claim 5,
wherein the convex portions are formed of a material with a friction coefficient larger than that of the dielectric body of the to-be-charged member.

12. The charging unit according to claim 11,
wherein the convex portions are formed of a material which more easily performs elastic deformation than the dielectric body of the to-be-charged member.

13. The charging unit according to claim 12 further comprising:
a transmission portion transmitting the rotation of the to-be-charged member to the charging roller,
wherein the transmission portion causes the circumferential surface of the convex portions disposed in both end portions of the roller body among the plurality of convex portions to contact the to-be-charged member, thereby transmitting the rotation of the to-be-charged member to the charging roller.

14. An image forming apparatus comprising:
a to-be-charged member including a dielectric body which can hold charge and rotating in a predetermined direction;
a charging roller disposed to face the to-be-charged member and including a conductive roller body and a plurality of insulating convex portions which has electric resistance greater than that of the roller body, is disposed in the area of the roller body in the an direction of the roller body with intervals therebetween, and protrudes in a radial direction of the roller body;
a feeding mechanism feeding a sheet between the to-be-charged member and the charging roller;
a recording head portion forming an image on the sheet held on the to-be-charged member; and
a discharge mechanism discharging the sheet on which recording was performed by the recording head portion.

15. The apparatus according to claim 14,
wherein the recording head portion includes an ink jet recording head.

16. The apparatus according to claim 14,
wherein each of the convex portions forms a ring consecutive in the circumferential direction of the roller body.

17. The apparatus according to claim 14,
wherein each of the convex portions is formed of a plurality of convex elements provided in the circumferential direction of the roller body with intervals therebetween.

18. The apparatus according to claim 14,
wherein the roller body includes a mandrel along the axis of the roller body and a cylindrical conductive member provided outside the mandrel.

19. The apparatus according to claim 14,
wherein the convex portions are formed of a material with a friction coefficient larger than that of the dielectric body of the to-be-charged member and more easily performs elastic deformation than the dielectric body.

20. The apparatus according to claim 19 further comprising:
a transmission portion transmitting the rotation of the to-be-charged member to the charging roller,
wherein the transmission portion causes the circumferential surface of the convex portions disposed in both end portions of the roller body among the plurality of convex portions to contact the to-be-charged member, thereby transmitting the rotation of the to-be-charged member to the charging roller.
